(19) United States
(12) Patent Application Publication
(10) Pub. No.: US 2011/0242811 A1
(43) Pub. Date: Oct. 6, 2011

(54) LED Assembly

(76) Inventor: Yu-Cheng CHENG, Taipei (TW)

(21) Appl. No.: 13/041,518

(22) Filed: Mar. 7, 2011

(30) Foreign Application Priority Data
Apr. 1, 2010 (TW) 099205723

(51) Int. Cl. F21V 21/00

(52) U.S. Cl. 362/249.03

(57) ABSTRACT

An improved LED assembly is disclosed comprising a circuit substrate and a frame. The circuit substrate has LEDs, conductive strips and a cover. The conductive strips are connected to the positive lead and negative lead of the LED. The cover has at least one opening and at least one bump on the surface, which helps the movement of the circuit substrate. The frame has an open end on the upper surface of the frame and extended along two sides of the open end horizontally further comprising two positioning structures in order to form a slot on the inner side of the frame. And conductive elements are formed on the inner side of the two positioning structures toward the slot so as to conduct the electric source to the circuit substrate and dissipate the heat.

### BACKGROUND OF THE INVENTION

1. Field of the Invention

The present invention relates to an improved LED assembly; in particular, it relates to an improved LED assembly which is to dispose a cover on the circuit substrate so as to protect the circuitry layout and the circuit substrate can slide to into the frame at a preferred position by the cover.

2. Description of Related Art

LED has the advantages of long service life, high energy efficiency, durability, resistance to vibrations, reliability, compactness, fast response and the fact that it may be massively produced. Therefore, LED has been used for the purpose of illumination. However, more heat is generated by LED when it is lit; therefore, a heat-dissipating module must be used to dissipate the heat into the ambient air. Hence, such heat-dissipating module is an indispensable part of an LED assembly.

The LED assembly of the prior art has the following two disadvantages in assembling:

1. In the prior art, LEDs are first disposed on an aluminum substrate and then the aluminum substrate is fastened onto a heat-dissipating module by screws or glue. Therefore, longer time is needed in manufacturing and cost of manufacturing is higher.

2. Also, each LED has to be electrically connected with a power source. Such connection takes longer time.

From the above, we can see that the LED assembly of the prior art has many disadvantages and needs to be improved.

To eliminate the disadvantages of the LED assembly of the prior art, the inventor has put in a lot of effort in the subject and has successfully come up with the improved LED assembly of the present invention.

### SUMMARY OF THE INVENTION

An objective of the present invention is to provide an improved LED assembly which comprising not only a cover on the circuit substrate so as to protect the circuitry layout on the circuit substrate, but also a bump to make it easier when moving the circuit substrate on the frame.

Another objective of the present invention is to provide an improved LED assembly which comprising a flange, which is disposed at the edge on the surface of the cover, and a guide channel, which is disposed along one side of the slot of the frame and guides the circuit substrate directionally into the frame. The guide channel is to prevent from mistakenly connecting the electrodes of the conductive strip of the circuit substrate and the conductive element of the frame which can burn the LED out.

Another objective of the present invention is to provide an improved LED assembly comprising a conductive strip, which is disposed on the circuit substrate, and the conductive strip can engage with the conductive element of the frame to conduct and transmit the heat from LED to the conductive element thereby achieving the purpose of fast cooling.

An improved LED assembly enabling achievements of aforementioned objectives comprises: a frame, a circuit substrate and a cover. The frame has an open end on the upper surface of the frame and extended along two sides of the open end horizontally further comprising two positioning structures in order to form a slot on the inner side of the frame. And one or more conductive elements are formed on the inner side of the two positioning structures toward the slot so as to conduct the power source. The circuit substrate has one or more LEDs or OLEDs and at least one conductive strip disposed on the circuit substrate. The conductive strip is connected to the positive lead and negative lead of the LED by means of the circuitry layout. The cover has one or more openings and a bump on the surface of the cover. The cover covers the circuitry layout on the circuit substrate to protect the circuit. When the circuit substrate slides into the frame, the LED is exposed and corresponding to the open end of the frame. Wherein the conductive strip of the circuit substrate can engage well to the conductive element of the frame to conduct the electricity through the conductive strip to light the LED and to achieve the purpose of heat-dissipating. The bump on the cover is to help the circuit substrate being moving easily into the frame at a preferred position.

### BRIEF DESCRIPTION OF THE DRAWINGS

FIG. 1 is a diagram showing the LED assembly of the present invention.

FIG. 2 is a diagram showing the LED assembly of the present invention in an assembled condition.

FIG. 3 is a cross-sectional view schematically illustrating the LED assembly of the present invention.

FIG. 4 is a diagram showing the second embodiment of the LED assembly of the present invention.

FIG. 5 is a diagram showing the third embodiment of the LED assembly of the present invention.

FIG. 6 is a diagram showing the implementation of the present invention.

### DETAILED DESCRIPTION OF THE PREFERRED EMBODIMENTS

The aforementioned and other technical contents, aspects and effects in relation with the present invention can be clearly appreciated through the detailed descriptions concerning the preferred embodiments of the present invention in conjunction with the appended drawings.

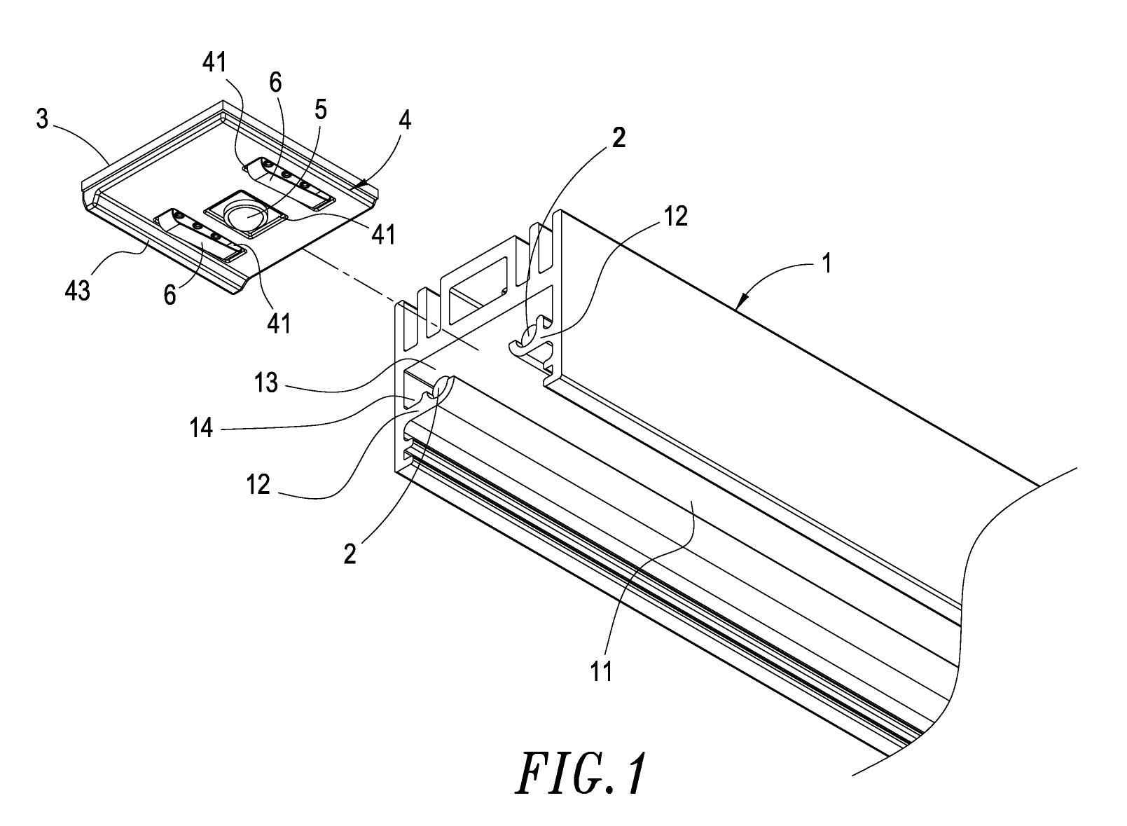

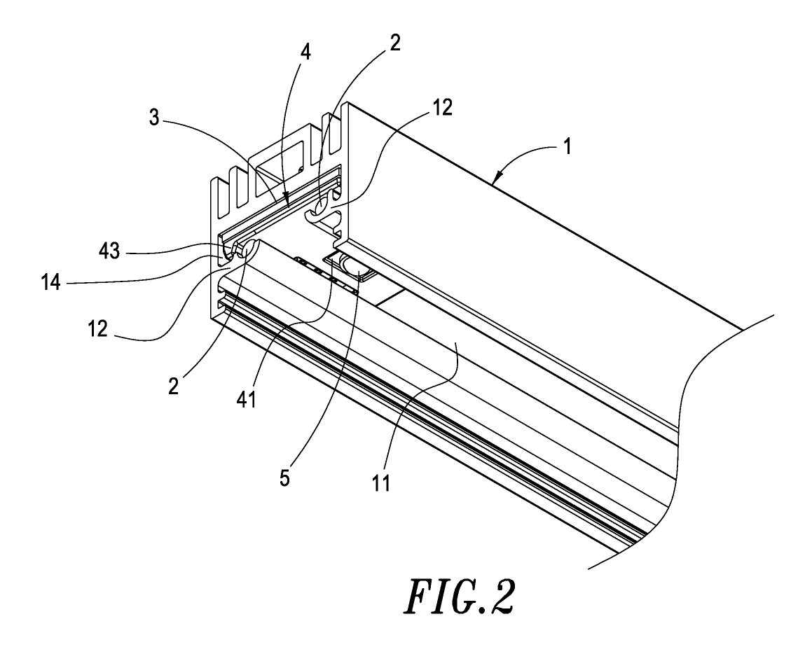

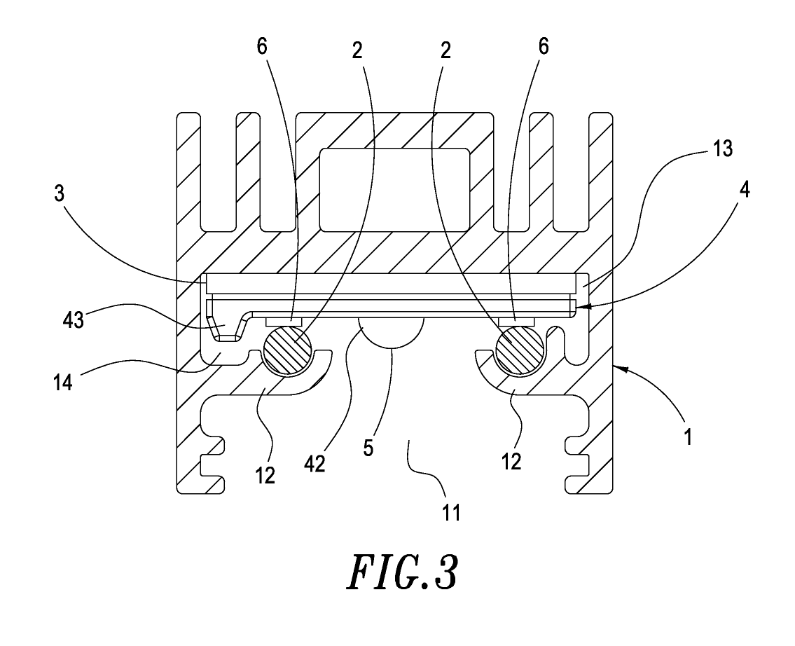

Refer now to FIGS. 1 to 3, wherein a diagram showing the LED assembly of the present invention are shown, and it can be seen that the LED assembly comprises:

a frame 1, having a open end 11 on the upper surface of the frame and extended along two sides of the open end 11 horizontally further comprising two positioning structures 12 in order to form a slot 13 on the inner side of the frame 1; one or more conductive elements 2 are formed on the inner side of the two positioning structures 12 toward the slot 13 so as to conduct electricity to the conductive elements 2;

a circuit substrate 3, having at least one LED 5 and at least one conductive strip 6 which is connected to the positive lead and negative lead of the LED 5 by means of the circuitry layout; and the conductive strip 6 can be in a inclined condition; besides, the circuit substrate 3 can be a thin board;

a cover 4, with a similar size to the circuit substrate 3, having one or more openings 41 and a flange 43 formed on the surface of the cover; and the cover is connected to the circuit substrate 3 and covers the circuitry layout on the circuit substrate 3 to protect the circuit; further, the opening 41 of the cover 4 exposes the LED 5 of the circuit substrate 3 and the conductive strip 6.

In order to avoid connecting the conductive strip 6 and the conductive element 2 wrongly and causing the LED 5 burn out, the circuit substrate 3 should slide into the slot 2 with direction. The flange 43 of the cover 4 should be disposed at the same side with the guide channel 14 of the frame 1, so that the circuit substrate 3 can slide into the slot 13 of the frame 1 and allows electrodes of the conductive element 2 be connected correctly to the positive lead and negative lead of the LED 5. When the circuit substrate 3 can slide into the slot 13 of the frame 1, the LED 5 of the circuit substrate 3 will correspond to the open end 11 of the frame 1, so as to allow the light of LED 5 scatter through the open end 11, and the conductive strip 6 of the circuit substrate 3 is engaged with the conductive element 2 of the frame 1 with a inclined condition and the power can be conducted directly into the conductive strip 6 and through to the LED 5 to light the LED 5.

In addition, the cover 4 can be adhered or fasten to the circuit substrate 3 or in other connected ways.

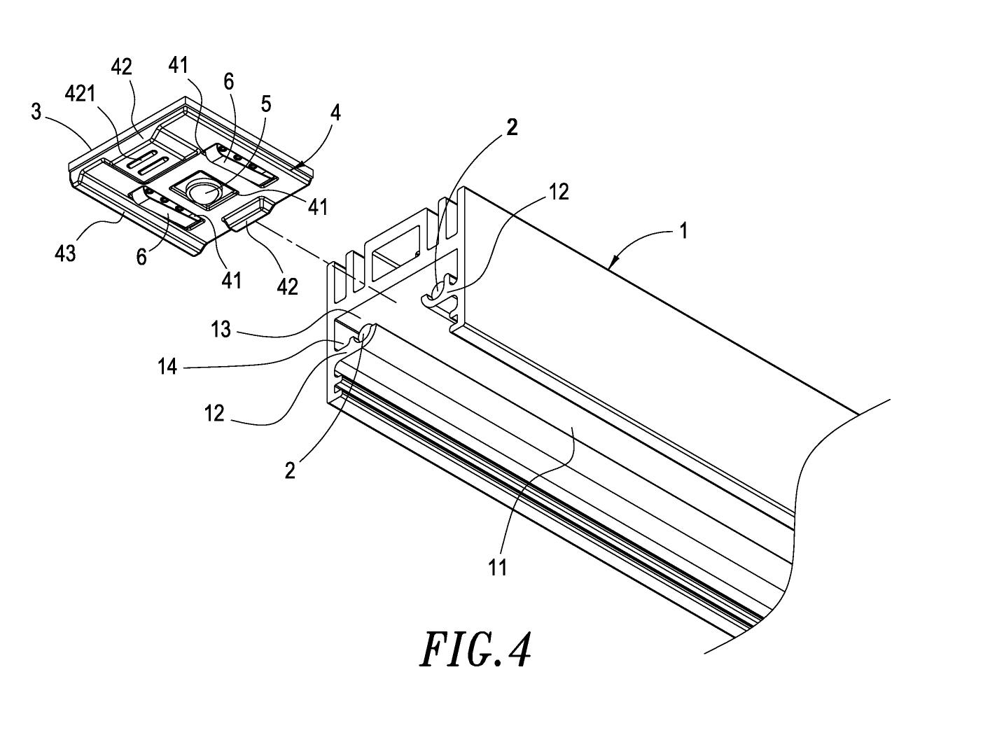

Refer to FIG. 4, wherein a diagram showing the second embodiment of the LED assembly of the present invention. The preferred embodiment is the mostly like the preferred embodiment in FIG. 1 in the aspect of structure, and it may not be described any further hereinafter. The difference is to disposed a bump 42, which comprising a slip-proof pattern 41 on it, to increase the thickness of the cover 4 and help the movement of the circuit substrate 3.

Preferably, the bump 42 can be disposed in the front end or in the rear end of the cover 4.

If the frame 1 is made of a metallic material, several heat-dissipating protrusions extending from the frame 1 may be used so that heat may be dissipated from the frame 1; and if the frame 1 is made of a metallic material, the conductive strip 2 should be electrically insulated from the frame 1 to avoid short circuit.

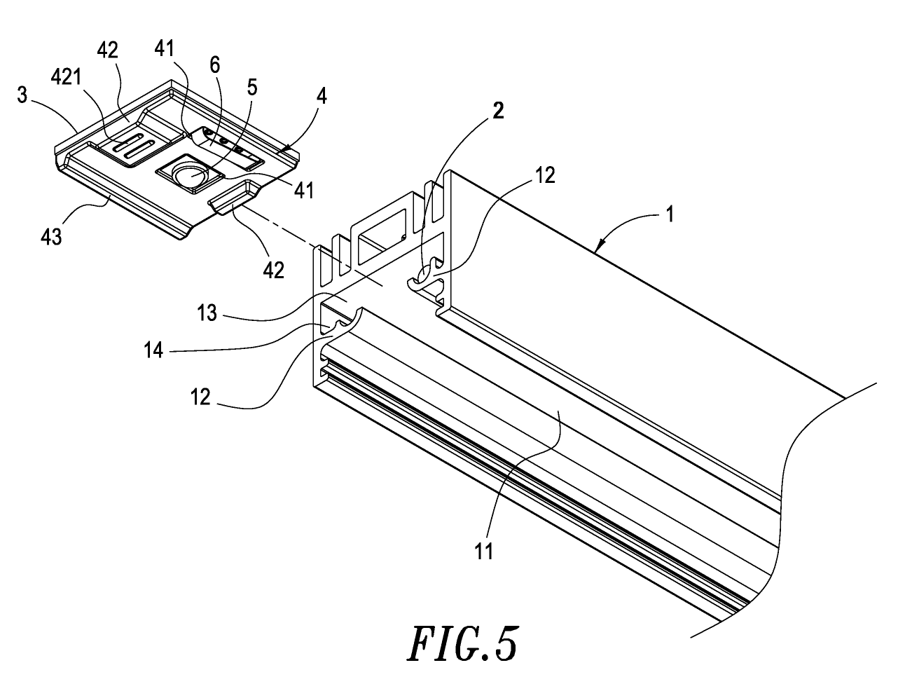

Refer to FIG. 5, wherein a diagram showing the third embodiment of the LED assembly of the present invention, the difference of FIG. 5 from FIG. 1 is to disposed only one conductive strip 6 on the circuit substrate 3 and the conductive strip 6 is connected to one of the electric lead of the LED 5, and the other electric lead of the LED 5 is connected to the circuit substrate 3. In assembly, the frame 1 is made of a metallic material and only one conductive element 2 is disposed on the frame 1, which should be electrically insulated. When conducting the power source to the conductive element 2 and the frame 1, with the circuit substrate 3 slid into the frame 1, the conductive strip 6 is engaged to the conductive element 2 of the frame 1 and the circuit substrate 3 is connect to the frame 1, therefore, the electric source can be transmit to the LED 5 so that the LED may be lit.

In addition, the conductive element 2 may be disposed on other places of the frame 1 besides the inner side of the positioning structure 12 so long as these conductive strips 6 of the circuit substrate 3 may be engaged with the conductive element 2 of the frame 1 after the circuit substrate 3 is slid into the frame 1.

Also, one or more LED 5 may be disposed on the circuit substrate 3 according to the size of the circuit substrate 3.

Also, the inclined condition of the conductive strip 6 described in any of the aforementioned embodiments is a preferred embodiment of present invention, but not to limit the scope of this invention. The conductive strip 6 can be in flat condition as well.

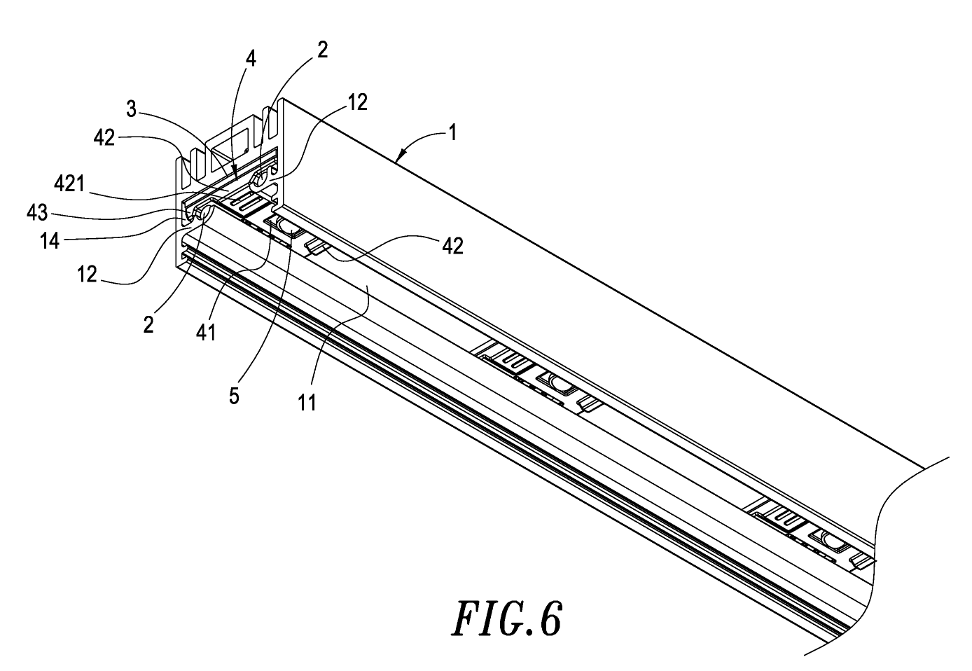

Refer to FIG. 6, where in a diagram showing the implementation of the present invention, one or more circuit substrate 3 may be slid into the frame 1 according to the length of the frame 1, by using the bump 42 of the circuit substrate 3 to move the circuit substrate 3 to a preferred position.

The LED 5 described in any of the aforementioned embodiments may be OLEDs.

In contrast to the LED assembly of the prior art, the LED assembly of the present invention has the following advantages:

1. In this invention, a cover is disposed on the circuit substrate so as to protect the circuitry layout on the circuit substrate, but also a bump to make it easier when moving the circuit substrate on the frame.

2. In this invention, a flange is disposed at the edge on the surface of the cover, and a guide channel is disposed along one side of the slot of the frame. So that, the circuit substrate can be slit directionally into the frame and it also helps to assemble the circuit substrate and the frame.

3. In this invention, the conductive strip is disposed on the circuit substrate and engaged to the conductive element of the frame. Not only to provide electric but also to transmit the heat to the conductive element to achieve the purpose of heat-dissipating.

Many changes and modifications in the above described embodiments of the invention can, of course, be carried out without departing from the scope thereof. Accordingly, to promote the progress in science and the useful arts, the invention is disclosed and is intended to be limited only by the scope of the appended claims.

What is claimed is:

1. An improved LED assembly, comprising:
a frame, having a open end on a surface of the frame and extended along two sides of the open end horizontally further comprising two positioning structures in order to form a slot; two conductive elements are formed on the inner side of the two positioning structures toward the slot so as to conduct electric source;
a circuit substrate, having at least one LED and at least one conductive strip which is connected to the positive lead and negative lead of the LED;
a cover, having one or more openings and connected to the circuit substrate, covered the circuitry layout on the circuit substrate; wherein, the LED and the conductive strips are outstanding and exposed via the opening exposes;
when the circuit substrate slides into the frame, the LED is exposed corresponding to the open end of the frame; wherein, the conductive strips of the circuit substrate are engaged well to the conductive elements of the frame in order to conduct the electricity through the conductive strips and light the LED, so that the purpose of heat-dissipating is achieved; wherein, the bump on the cover is to help the circuit substrate being moving easily into the frame at a preferred position.

2. The improved LED assembly according to claim 1, wherein the slot comprises a guide channel in one side of the slot; wherein the cover includes a flange at the edge of the cover on the surface, so as to make the circuit substrate slide into the slot in correct direction.

3. The improved LED assembly according to claim 1, wherein a bump is disposed on the cover in order to increase the thickness and help the movement of the cover.

4. The improved LED assembly according to claim 3, wherein the bump further includes a slip-proof pattern.

5. The improved LED assembly according to claim 3, wherein the bump is disposed in the front end or in the rear end of the cover.

6. The improved LED assembly according to claim 1, wherein the frame is made of metallic material and the frame is electrically insulated from the conductive strip.

7. The improved LED assembly according to claim 1, wherein the LED is replaceable with OLED.

8. The improved LED assembly according to claim 1, wherein the size of the cover is similar to the size of circuit substrate in order to cover the circuitry layout completely.
